(19) United States
(12) Patent Application Publication
(10) Pub. No.: US 2010/0192571 A1
(43) Pub. Date: Aug. 5, 2010

(54) Turbocharger Having a Turbocharger Housing

(75) Inventors: Ralf Böning, Reiffenbach (DE); Hartmut Claus, Grunstadt (DE); Dirk Frankenstein, Worms (DE); Holger Fäth, Fussgonheim (DE); Jochen Held, Bolanden-Weierhof (DE); Stefan Krauss, Gruenstadt (DE); Stefan Nowack, Kirchheimbolanden (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/664,702

(22) PCT Filed: Jun. 11, 2008
(86) PCT No.: PCT/EP2008/057251

§ 371 Date: Apr. 13, 2010

(30) Foreign Application Priority Data
Jun. 18, 2007 (DE) 10 2007 027 869.3

(51) Int. Cl. F01D 25/18; F01D 25/16; F01D 25/24; F02B 33/40

(52) U.S. Cl. 60/605.3; 415/229; 415/230

(57) ABSTRACT

A turbocharger has a turbocharger housing and a through opening for a shaft. The shaft is pivotally supported in the housing by way of a bearing arrangement. Lubricating oil is supplied for lubricating the bearings. A section of the shaft is provided on the outside of at least one bearing, the section forming a gap together with the housing. The gap is configured as a lubricating oil regulator in order to at least reduce a passage of lubricating oil from the sides of the bearing.

The invention relates to a turbocharger having a turbocharger housing, in which at least one rotor, like a turbine wheel and/or a compressor wheel is supported.

Turbochargers normally comprise a housing, in which a turbine wheel and a compressor wheel are rotatably supported on a shaft by means of radial bearings. In this way, the shaft can reach revolutions of up to 300.000 U/min for instance. At least one axial bearing can also be provided for instance in order to receive the developing axial forces. The bearings are lubricated here by means of a corresponding lubricating oil.

The turbocharger and its oil-lubricated bearing may result in oil losses in the turbine and/or the compressor. A dynamic seal takes place in turbochargers by way of piston rings, these are however unable to adequately prevent a transfer of lubricating oil to the turbine side and/or to the compressor side. As a result of the latest exhaust gas technology, a transfer is to be prevented as far as possible particularly on the turbine side, since this can result in the soot particle filter and/or catalytic converter slagging for instance, thereby resulting in its efficiency being massively impaired.

Accordingly, the object of the present invention is to provide a turbocharger housing, which is provided with an oil regulator, which at least reduces a transfer of lubricating oil to the turbine side and/or to the compressor side.

This object is achieved by a turbocharger housing with the features of claim 1.

Accordingly, a turbocharger with a turbocharger housing is provided in accordance with the invention with;
a through opening for a shaft,
with the shaft being rotatably supported in the housing by means of a bearing arrangement
with lubricating oil being supplied to lubricate the bearing and
with a section of the shaft being provided on the outside of at least one bearing, the section forming a gap together with the housing, said gap being embodied as a lubricating oil regulator in order to at least reduce a passage of lubricating oil from the sides of the bearing.

The bearing is advantageous here in that the lubricating oil flow through the lubricating oil regulator can be regulated so that the flow of lubricating oil to the turbine wheel and/or compressor wheel can be significantly reduced or essentially totally prevented. As a result, a slagging of the soot particle filter and/or of the catalytic converter can be prevented and thus the efficiency thereof maintained, contrary to the prior art, as was described above.

Advantageous embodiments and developments of the invention result from the subclaims as well as the description with reference to the drawings.

According to an embodiment of the invention, the gap comprises a gap height, which is suited to regulating a lubricating oil flow. Such a gap is advantageous in that it represents an embodiment which is very simple and easy to produce in order to provide an oil regulator.

In a further embodiment of the invention, at least one sealing element is arranged in the gap in order to reduce or essentially prevent a passage of oil. This likewise represents an embodiment which is simple and easy to produce in order to form an oil regulator. In this process the gap can optionally also be selected to be slightly larger than the variant without a seal by providing an additional seal

In another inventive embodiment, a depression is provided in the shoulder of the shaft, with the depression being arranged in connection with the gap, and being used to receive lubricating oil which passes through the oil regulator. In this process, lubricating oil can be collected and retained in the depression.

According to another inventive embodiment, a recess is arranged in the housing in connection with the gap, with the housing and the shaft forming a chamber for receiving an decompression volume of lubricating oil. This is advantageous in that a part of the lubricating oil can initially be retained in this chamber.

In another inventive embodiment, the gap is arranged on the side of the shaft, to which the turbine wheel and/or the compressor wheel is fastened, so that an oil regulator can be provided in order to prevent an uncontrolled flow of oil to the turbine wheel and/or compressor wheel. This is advantageous in that such an oil regulator can basically be arranged on both the turbine side and also on the compressor side.

In another inventive embodiment, a drain for the lubricating oil of the bearing arrangement is provided in the housing. As a result, the oil can be drained off very easily. The oil drain can be connected here to the chamber in which the decompression volume collects or to the depression which lies opposite to a collection chamber. These are however only some examples of where the oil drain can be provided. The invention is however not restricted hereto. The oil drain can be arranged at any point, which is suited to draining off lubricating oil and preventing a passage of oil to the turbine wheel and/or compressor wheel.

According to a further inventive embodiment, an oil collection chamber is arranged opposite to the shoulder of the shaft. This is advantageous in that lubricating oil, which is spun away by the shaft, can be received in the oil collection chamber.

In another inventive embodiment, a corresponding depression in the shoulder is provided in the shaft opposite to the oil collection chamber. This is advantageous in that lubricating oil which is collected in the oil collection chamber can at least be partly collected in the depression. As a result, the lubricating oil can be retained before reaching the turbine or compressor wheel.

The invention is subsequently explained in more detail with reference to the exemplary embodiments specified in the schematic Figures of the drawings, in which;

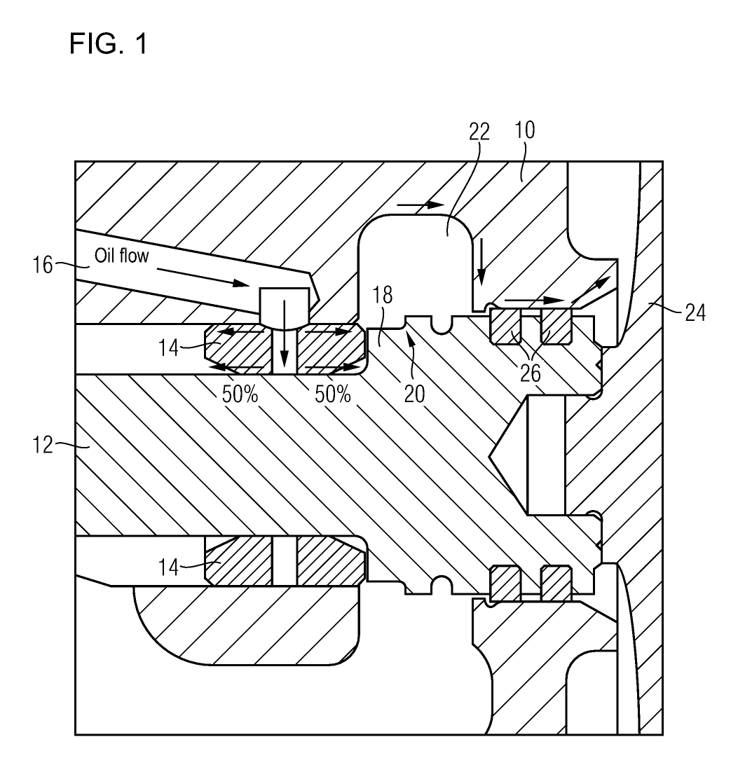

FIG. 1 shows a sectional view of a cutout of a turbocharger housing according to the prior art;

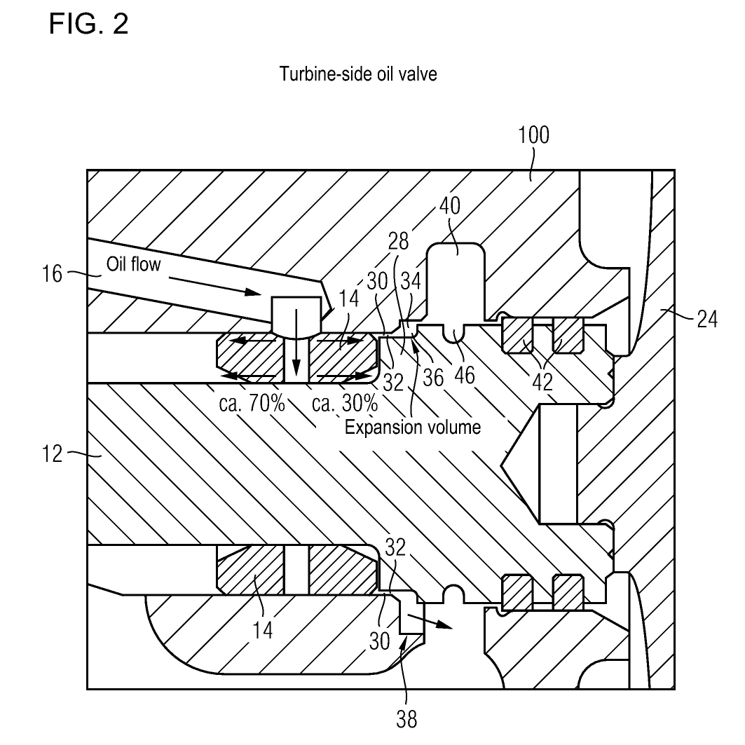

FIG. 2 shows a sectional view of a turbocharger housing according to a first embodiment of the invention and

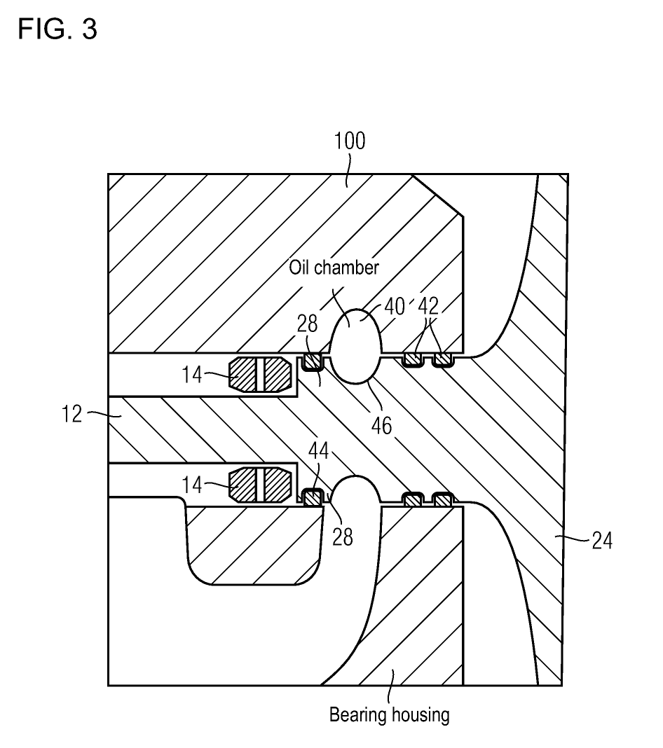

FIG. 3 shows a sectional view of a turbocharger housing according to a second embodiment of the invention.

The same and/or functionally-similar elements and apparatuses, unless otherwise specified, are provided with the same reference characters in the all the figures.

FIG. 1 shows a sectional view of a cutout of a turbocharger housing 10 according to the prior art. A turboshaft 12 is arranged in the housing 10, said turboshaft being rotatably supported on each side by way of a radial bearing 14 in each instance. A lubricating oil supply 16 is provided to lubricate the bearing 14, for instance in the form of a borehole, through which lubricating oil is conveyed to the bearings 14. A raised shoulder 18 with a centrifugal oil edge 20 is provided on the outside of the radial bearing shown 14 shown in FIG. 1. The centrifugal oil edge 20 lies opposite to an oil collection chamber 22 in the housing 10 of the turbocharger. In connection with the centrifugal oil edge, the shoulder 18, to the end of which a turbine wheel 24 is fastened, is provided with two piston rings and/or piston ring seals 26 for sealing purposes.

The following occurs during operation with the lubricating oil. The lubricating oil which is fed to the radial bearing 14 by way of the oil supply 16 escapes axially out of the bearing, as indicated with the arrows in FIG. 1. Almost 50% of the lubricating oil escapes here in both directions of the respective bearing 14, as indicated by the arrows in FIG. 1.

The escaped lubricating oil is spun out of the centrifugal oil edge 20 by the turboshaft 12 and is collected in the opposite oil collection chamber 22 of the turbocharger housing 10 and is drained downwards toward the shoulder of the shaft 12. Despite the piston ring 26 provided, an oil passage to the turbine and/or to the turbine wheel 24 is easily possible here in the case of unfavorable pressure conditions with the known consequences, like the contamination of soot particle filters and catalytic converter.

To prevent or at least restrict this passage of lubricating oil, a turbocharger housing 100 is provided in accordance with a first embodiment of the invention, as shown in FIG. 2.

The turbocharger housing 100 here firstly likewise comprises two radial bearings 14 on each side of the turbo shaft 12 for instance. Lubricating oil is supplied to the respective bearing 14 by way of an oil supply 16. A raised shoulder 28, as shown in FIG. 2, is embodied here on the outside of the one radial bearing 14. With the other radial bearing (not shown), this shoulder 28 can accordingly also be provided on the other side. This applies to all inventive embodiments.

Here the raised shoulder 28 embodies a narrow gap 30 with the turbocharger housing 10 on its front end. Here the gap 30 is at least partially or completely circumferential and forms an oil regulator 32. This prevents the majority of the lubricating oil, for instance 70%, from escaping in the direction of the turbine wheel but instead escaping in the opposite direction, as indicated with the arrows in FIG. 2.

Only 30% of the lubricating oil moves toward and/or through the gap 30 for instance. The specifications of 70% and 30% are only exemplary here.

In connection with this gap 30, a recess 34 is provided in the turbocharger housing 100, as shown in FIG. 2, in order to form a chamber 36 for receiving a decompression volume of lubricating oil. A corresponding depression (not shown) can also be provided in the shoulder 28 here. Alternatively, instead of the recess 34, only the depression (not shown) can be provided in the shoulder in order to form a chamber for a decompression volume.

A lubricating oil guide and/or oil drain 38 is also provided in the turbocharger housing 10, from which the lubricating oil, which was collected in the recess 34 for instance, can suitably flow out without passing over the turbine and/or the turbine wheel 24 in the process.

The oil collection chamber 40 is provided in connection with the recess 34, in which chamber lubricating oil which reaches the shoulder 28 in this region and is spun out by the shaft 12 can be collected. A depression 46 in the shoulder is embodied 28 opposite to the oil collection chamber 40, in which depression the lubricating oil collected in the oil collection chamber 40 can be received and is as a result not directly forwarded in the direction of the turbine wheel 24. In connection with the oil collection chamber 40, a piston sealing arrangement is provided on the shoulder, on which two piston seals 42 are provided for instance.

By selectively guiding the lubricating oil which flows out of the bearing 14, here in FIG. 2 for instance by way of the oil regulator gap 30 and the recess 34 and the guide 38 for draining the lubricating oil in the turbocharger housing 100, it is possible to efficiently prevent large quantities of oil from reaching the piston ring seal 42 and from passing here across the turbine and/or the turbine wheel 24 in the event of unfavorable pressure conditions.

A second embodiment of the inventive turbocharger housing 100 is shown in a schematic and extremely simplified form in FIG. 3.

A shaft 12 is likewise rotatably supported here in the turbocharger housing 100 by means of radial bearings 14. The lubricating oil supply for supplying lubricating oil to the bearings 14 has been left out here for reasons of clarity. As in the first embodiment, a raised shoulder 28 is provided on the outside of the bearing 14. The shoulder 28 here forms a gap 30 with its front end here, said gap being at least partially or totally circumferential, with at least one sealing element 44 being provided in the gap 30, in order to form an oil regulator. In this way, the sealing element 44 can be a piston ring seal.

The oil collection chamber is provided in connection with the gap 30, with a corresponding depression 46 in the shoulder 28 being provided opposite to the oil collection chamber 40. The depression 46 can likewise be embodied here partially or completely circumferentially. If a part of the lubricating oil reaches this region of the shoulder 28, despite the oil regulator 32, the lubricating oil can be spun out by the shoulder 28 and collected in the oil collection chamber 40. The lubricating oil is however fed back and in this way reaches the depression 46 on the shoulder 28, said depression being disposed at least partially or completely opposite the receiving chamber 40. The depression 46 in the shoulder 28 of the shaft 12 renders it considerably more difficult for the lubricating oil to escape sideways and to permeate into the turbine region and/or toward the turbine wheel 24 across a subsequent piston ring seal 42. A lubricating oil supply 16 and a lubricating oil discharge and/or an oil drain 38, like in the first embodiment for instance, were omitted for reasons of clarity.

Although the present invention was previously described with reference to the preferred exemplary embodiments, it is not restricted hereto but can be modified in numerous ways. The previously described embodiments can be combined with one another here, in particular individual features thereof.

In particular, the present embodiments of the inventive turbocharger housing 10 can also be combined with one another. In particular, individual features of the two embodiments can be combined with one another without departing from the scope of protection of the claims.

In the second embodiment for instance, provision can be made for the receiving chamber 36 and/or the recess 34 of the first embodiment instead of the depression 46 or in addition to the depression 46. It is however basically also conceivable to also provide the receiving chamber 36 in the second embodiment for instance, with it being possible to optionally provide at least one or several seals in front or behind of said receiving chamber 36.

Furthermore, the oil regulator 32 in the form of a gap 30 without an additional seal 44, in accordance with the first embodiment, can also be provided in the second embodiment. This form of the oil regulator 32 of the first embodiment can be provided in addition to or alternatively to the oil regulator 32 of the second embodiment. Conversely, the oil regulator 32 can also be provided in the first embodiment by means of a seal 44 of the second embodiment, namely alternatively or in addition thereto.

Furthermore, with both inventive embodiments, in addition to the two piston ring seals 42 at the end upstream of the respective rotor, as shown in FIGS. 2 and 3, only a piston ring seal 42 or more than two piston ring seals 42 can be provided. Another seal can however also basically be arranged, which is essentially suited to preventing or at least eliminating a passage of lubricating oil.

The present invention and the two embodiments are also not restricted to reducing or essentially preventing the passage of lubricating oil in the turbine. The turbocharger housing 10 on the side of the turbine and/or of the compressor can basically be provided with an oil regulator 32. The two inventive embodiments, as shown in FIGS. 2 and 3, can likewise be transferred to the compressor and/or the compressor side. This also applies to the previously described combinations of the first and second embodiment.

1-11. (canceled)

12. A turbocharger, comprising:
a turbocharger housing formed with a through opening;
a shaft disposed in said through opening;
a bearing rotatably supporting said shaft in said housing and a feed of lubricating oil for lubricating said bearing;
said shaft having a raised shoulder disposed outside of said bearing, said shoulder forming a gap together with said housing, said gap forming a lubricating oil regulator to reduce or eliminate a passage of lubricating oil from the sides of the bearing; and
said housing having a recess formed therein adjoining said gap, wherein said housing and said shaft form a chamber for receiving a decompression volume of the lubricating oil.

13. The turbocharger according to claim 12, wherein said bearing is a bearing of a bearing assembly with a plurality of bearings.

14. The turbocharger according to claim 12, wherein said gap is configured with a gap height that is suited to regulating a lubricating oil flow.

15. The turbocharger according to claim 12, which further comprises at least one sealing element disposed in said gap, for reducing or substantially preventing a passage of oil.

16. The turbocharger according to claim 12, wherein said shoulder of said shaft is formed with a depression, and said depression and said gap are configured to receive lubricating oil that passes through an oil regulator.

17. The turbocharger according to claim 12, wherein said gap is formed at least partially about a circumference of said shaft.

18. The turbocharger according to claim 12, wherein said gap is formed completely about a circumference of said shaft.

19. The turbocharger according to claim 12, wherein said gap is formed at a side of said shaft carrying a turbine wheel and/or a compressor wheel of the turbocharger.

20. The turbocharger according to claim 12, wherein said housing is formed with a drain for the lubricating oil of said bearing.

21. The turbocharger according to claim 12, wherein an oil collection chamber is arranged opposite said shoulder of said shaft.

22. The turbocharger according to claim 21, wherein said depression in said shoulder of said shaft is formed opposite said oil collection chamber.

23. A motor vehicle, comprising a turbocharger according to claim 12.
